(19) United States
(12) Patent Application Publication
(10) Pub. No.: US 2008/0183573 A1
(43) Pub. Date: Jul. 31, 2008

(54) Method and Apparatus for Increasing Accessibility and Effectiveness of Advertisements Delivered via a Network

(76) Inventor: James Edward Muschetto, Citrus Heights, CA (US)

Correspondence Address: JAMES EDWARD MUSCHETTO, 770 CALIFORNIA ST., APT. 208, SAN FRANCISCO, CA, 94108, US

(21) Appl. No.: 11/669,819

(22) Filed: Jan. 31, 2007

(51) Int. Cl. G06Q 30/00; G06F 17/30

(52) U.S. Cl. 705/14

(57) ABSTRACT

Network-delivered advertisements, and in particular Internet advertisements, are provided increased accessibility and effectiveness through automatic collection of ads, and later presentation of those ads by users. Typically, a publisher modifies a source file (e.g. an HTML file) to include the invention's software and metadata identifiers that uniquely identify advertising content in the source file. When the file is transferred and presented to a user, the invention's software, operating in conjunction with presentation software (e.g. a web browser), locates the metadata identifiers within the presentation (e.g. a displayed web page) and uses them to identify the portions of advertising content associated with those metadata identifiers. The portions of advertising content are then collected and transmitted to a server computer that stores them in a database so that they are associated with a user-identification code retrieved from the user's computer. The invention's software also provides each of the displayed advertisements with an associatively positioned operator control. A user of the invention may then use those operator controls to navigate among and retrieve advertisements previously viewed by that user and stored in the server computer's database. Additionally, a user may enter a login and password to assign the user-identification code to additional computers operated by the user, and thereby enable collection and viewing of advisements on multiple computers. Thus, network-delivered advertisements are provided increased accessibility and effectiveness.

### FEDERALLY SPONSORED RESEARCH

Not Applicable

### SEQUENCE LISTING OR PROGRAM

Not Applicable

### FIELD OF THE INVENTION

This invention relates generally to increasing the accessibility and effectiveness of advertisements delivered via a network, and in particular, the effectiveness of Internet-delivered advertisements embedded within HTML documents and software products.

### BACKGROUND—DESCRIPTION OF PRIOR ART

Rapid adoption by computer users of the Internet and World Wide Web (WWW) has led to considerable development of Internet advertising tools to promote products and services to those users. Perhaps the most commonly used tool among these is known in the art as the “banner ad” (e.g. a “banner advertisement.”) Such banner ads may be generally characterized as a square or rectangular region within the body of a web page, that displays a textual or graphical advertising message, and that responds to a user's selection (e.g. a “mouse click” or other selection method) by routing the user's web browser to a web page selected by the ad's associated advertiser.

Since their introduction in 1994, banner advertisements have evolved from simple hyperlinked images embedded in web pages, to complex animated presentations and ads dynamically selected through analysis of a user's content choices, past product purchases, ad-selection history, and other factors. All banner ads, however, share two common goals—to expose a banner ad's content to a user and induce a him or her to select the ad, thereby routing the user's web browser to an advertiser's website. In the art, such exposure to a banner ad is referred to as an “impression” and such selection and routing of a user is known as a “click-through.” Based on the number of impressions and click-throughs recorded for an ad, compensation is typically provided by an advertiser to the publisher of the web page displaying the ad. Such recording is frequently performed by a “tracking service” (such as DoubleClick, Inc., of New York, N.Y.) acting as a reliable third party between an advertiser and a website's publisher. Such tracking services typically serve the banner ads they track via dedicated advertising web servers (e.g. “ad servers.”) Specifically, as a publisher's web page is loaded into a user's web browser, a URL (uniform resource locator) specification in a HTML (hypertext markup language) tag within that web page causes the user's browser to issue a HTTP (hypertext transfer protocol) request for a specific banner ad from a tracking service's ad server. That ad is transferred to the user's web browser and the ad's associated impression is recorded by the tracking service.

Further development of banner ads has been driven by the needs of website publishers to maximize the value of prominent advertising locations within their web pages. Such publishers began selling placement of multiple banner ads within the physical space of a single banner ad by sequentially presenting those banners at timed intervals. This type of advertisement is known in the art as a “rotating banner ad” and it enables website publishers to display additional advertisements during the time a user spends reading or viewing content on a web page. Such rotating banner ads are particularly effective on a website's home page because users may be served new advertisements when returning to that page after viewing other pages within the website. In addition to simple cycling of a fixed selection of banners, rotating banner ads are often dynamically loaded with a sequence of advertisements chosen through analysis of a user's content choices, past product purchases, ad-selection history, and other factors. Banner ads chosen through such analyses are often referred to as “targeted banner ads.”

It is commonly assumed that Internet users tend to regard website advertising as an undesirable but necessary aspect of Internet publishing. However, history has shown that Internet users not only respond to such advertising, but also tend to exhibit on-line shopping behavior that mirrors their shopping behavior in traditional “brick-and-mortar” stores. A fundamental component of such behavior is one of the most widely shared traits of human nature, the decision to decline immediate commitment yet eventually commit after a period of reconsideration. This behavior is commonly referred to as “having second thoughts” and traditionally contributes to a substantial portion of retail sales. One on-line manifestation of this behavior is a user's growing desire, after following one or more hyperlinks to various web pages, to return to a previous page displaying a particularly tempting banner ad. For example, a banner ad for a somewhat expensive product (a tropical cruise, for example) might be less likely to receive a user's immediate selection when first viewed. Such a user would be more likely to visit other web pages while he or she consciously or subconsciously ponders the benefits of that ad's proposition. This consideration process might require seconds, hours, perhaps a day or more, before a user reaches a point of justification for returning to such an ad. The next logical step for such a user is to locate the web page containing that ad using his or her browser's navigational tools. It is during this navigational process that users are confronted with problems that are not adequately addressed in the prior art.

For users seeking advertisements viewed during brief browsing sessions, a typical web browser's navigational tools may suffice. Such a user might simply use the “back” button on his or her browser to step backward through a few previously viewed web pages. However, users needing to search through periods of several hours, or even days, will find their web browsers poorly suited to the task. This is because the navigational tools presently offered in all popular web browsers provide no means for their users to identify previously browsed pages based on page content. Such tools are primarily designed to display lists of page titles of previously viewed pages, organized alphabetically, or by time of initial retrieval, or by occurrence of a user-supplied search term within those page titles. Simply put, navigation in all popular web browsers is “page-oriented” rather than “content-oriented.” Although U.S. Pat. No. 6,460,060 by Maddalozzo, Jr. et al., describes an invention for searching previously viewed textual content in a web browser's cache file, history file, and bookmarks file, it offers no means for searching previously viewed graphical content such as a banner ad.

To use a typical web browser to find a banner ad viewed within a range of hours or days, a user might try scrolling through the browser's history list. With luck, one title in that lengthy list of titles might indicate the web page containing the user's desired banner ad. Unfortunately, a web page's title rarely relates to advertisements within its page. That user might also trust his or her memory enough to try directly accessing the presumed page using a bookmark or by typing the page's address into the address bar of his or her browser. However, the likelihood that a casually browsed page will be bookmarked, or its address remembered a day later, is generally minimal. That user might even attempt to deduce the address of the banner ad's advertiser from his or her recollection of the ad's content. In this case, the user must rely entirely on his or her memory, ingenuity, and luck, rather than suitable navigational tools. Whenever a user fails to access a desired banner ad, the result is not only an unhappy Internet user who has lost time and productivity; the banner's advertiser is deprived of a potential customer and a website's publisher is deprived of revenue from an additional impression and click-through. Furthermore, an Internet user who commits to navigating back to a specific banner ad may be considered of higher value to an advertiser than a user who casually selects an ad when it is first viewed.

Although rotating banner ads and dynamically selected banner ads offer clear benefits to advertisers and website publishers, they present additional problems to Internet users seeking previously viewed ads. The first of these problems involves the Internet navigational tool that is second in use only to the hyperlink itself—the “back” and “forward” button system found on all popular web browsers. The operation of these buttons is well understood by those skilled in the art, as well as by casual Internet users. Simply put, a web browser's back button enables a user to step backward chronologically through a sequence of web pages visited since the browser was started. Likewise, a web browser's forward button (enabled after back button use) permits loading of web pages selected in forward order within that sequence. A web page becomes the most recent page in that sequence whenever a user directly loads it (e.g. selects a browser's bookmark, a hyperlink, etc.) Loading a new page following use of a browser's back button causes any web pages accessible via the browser's forward button to be removed from that sequence of pages. Unfortunately, when Internet users attempt to view rotating banner ads or dynamically selected banner ads on previously viewed web pages, they are often disappointed to find their browsers' back and forward buttons have returned those pages without the desired ads.

This is because the contents of such ads can change independently of a browser's page transitions. Therefore, a different banner ad may be found at the same page location where a user hoped to find a desired ad.

U.S. Pat. No. 6,892,181 by Megiddo, et al., describes an invention that operates typically as a software process integrated into a user's web browser. By monitoring differences between the URL references to banner ads in previous and currently viewed versions of web pages, that invention generates one or more additional browser windows displaying a collection of past and current banner ads. The invention is further described as having means to respond to a user's selection within a currently viewed banner ad by generating an additional browser window displaying ads previously displayed at that banner ad's location in earlier versions of its web page. To support such functions, that invention must directly monitor the cache file of its associated web browser, manipulate expiration data within cached web pages, and monitor user activity within the browser's graphical user interface (GUI.)

The invention described in the Megiddo, et al., patent, however, is not without limitations. That invention's only described means for discerning advertisements within web pages, and identifying advertisement changes between versions of pages, is the comparison of hyperlinked image tags within those pages. Hyperlinked image tags, however, have many applications beyond providing banner advertisements within web pages. Such tags are often used as graphical controls (e.g. “buttons”) for website navigation, or small images (e.g. “thumbnails”) that are hyperlinked to larger images, and other elements limited only by the imaginations of website designers. Because the Megiddo, et al., patent does not describe, nor refer to, any means to differentiate advertising that uses hyperlinked image tags from other content employing that same HTML structure, the described invention may identify and collect non-advertising items as if they were banner ads. Furthermore, Internet advertising is often presented using a variety of media types that do not use HTML image tags (Flash presentations, for example.) Even HTML forms are used as advertisements by inducing potential customers to submit information and proceed to an advertiser's web site. The invention described in the Megiddo, et al., patent does not describe, nor refer to, any means to identify such alternate types of Internet advertising.

U.S. Pat. No. 6,496,857 by Dustin, et al., describes an invention that provides a banner advertisement containing a selection area that, when selected by a user, will cause the ad to be stored in a networked storage system. To view thumbnail images of the user's selected ads, he or she must subsequently visit a web page supplied by that invention's server computer. The invention's effectiveness, however, depends on a user recognizing, upon an ad's initial viewing, that the ad is of sufficient interest to merit immediate action to save it. As described above, a common trait of human nature is that people often forego immediate action while consciously or subconsciously considering the value of an offer. Furthermore, a person's need or desire for a product frequently does not arise until well after his or her exposure to the product through advertising. A user failing to store a rotating banner ad using the invention described in the Dustin, et al., patent would likely find the ad inaccessible if he or she chooses to return to the ad's page even moments later.

U.S. Pat. No. 7,028,268 by Conley, Jr., describes an invention that incorporates a GUI element into a banner ad. That invention attaches a GUI selection list to a banner ad for the purpose of allowing a user to choose among a variety of hyperlinks to Internet URLs, thereby permitting a single banner ad to route the user to multiple Internet destinations. That invention, however, neither anticipates, nor provides means for, identifying, displaying, listing, or navigating among previously viewed banner ads.

In conclusion, it can be seen that Internet users, website publishers, and advertisers would all benefit if those users could easily access previously viewed advertisements. Unfortunately, popular Internet navigational tools do not permit such specialized access. Although efforts to provide means to display previously viewed banner ads have been made in the prior art, such means have limitations that seriously impact their practicality and usefulness to Internet users. Presently, the lack of a simple, practical tool to aid users in viewing previously viewed ads clearly limits the accessibility and effectiveness of network-delivered advertisements.

### OBJECTS AND ADVANTAGES

Accordingly, the objects and advantages of the present invention relate to serving the needs of Internet users, website publishers, and advertisers for increased accessibility, and effectiveness of advertisements delivered via a network. Objects and advantages of the present invention are:
(a) to provide the invention's users with easy, intuitive access to their previously viewed advertisements;
(b) to provide a user of the invention with his or her previously viewed advertisements, even when the user's browsing sessions occur on multiple computers;
(c) to provide the full benefit of the invention “passively” to users, without requiring them to manually install the invention into their computers or make immediate judgments about the advertisements to be collected;
(d) to provide the invention's small, unobtrusive controls in locations where users considering advertising are likely to look—on, adjacent, overlapping, or near each advertisement within a web page;
(e) to provide all results of a user's interaction with the invention, logically and conveniently at his or her point-of-control, thereby encouraging intuitive use of the invention;
(f) to provide website publishers with means to increase impression and click-through revenue by providing access to publishers' ads long after users have left initial advertising pages;
(g) to provide website publishers with means to apply the invention to all advertisements in their websites, regardless of underlying technical construction of the ads or the sources (advertising services) from which those ads are retrieved;
(h) to provide advertisers with additional customers who, unaided by the present invention, might have failed to find and select the advertisers' ads they'd previously viewed.

Still further objects and advantages will become apparent from a consideration of the ensuing description and drawings.

### SUMMARY OF THE INVENTION

In the preferred embodiment of the invention, an HTML file is modified to include the invention's software, and metadata identifiers that uniquely identify advertising content (e.g. advertising related HTML code portions) within the HTML file. The HTML file is transferred using a network (e.g. the Internet) to a user's computer where a web browser displays a web page derived from the HTML file. The invention's software, operating in conjunction with the web browser, locates the metadata identifiers within the interactive presentation and uses them to identify the portions of advertising content associated with those metadata identifiers. The portions of advertising content are then collected, along with textual descriptions of those advertisements contained within the metadata identifiers, and transmitted to a server computer that stores them in a database. The portions of advertising and their textual descriptions are associated in the database with a user-identification code retrieved from the user's computer. The invention's software also provides each of the displayed advertisements within the web page, an associatively positioned operator control. A user of the invention may then use those operator controls to navigate among and retrieve advertisements previously viewed by that user and stored in the server computer's database. Additionally, a user may enter a login and password to assign the user-identification code to additional computers used by the user, and thereby enable collection and viewing of his or her advisements on multiple computers. Thus, network-delivered advertisements are provided increased accessibility and effectiveness.

### BRIEF DESCRIPTION OF DRAWINGS

FIG. 1 provides a diagram of a general-purpose computer that can be used in one embodiment of the invention.

FIG. 2 provides a diagram of computers and network interconnections used to implement the invention according to one embodiment of the invention.

FIG. 3 provides examples of a variety of banner advertisements and their associated instances of the invention's operator control according to one embodiment of the invention.

FIG. 4A provides an example of a banner advertisement prior to operation of the invention's operator control according to one embodiment of the invention.

FIG. 4B provides an example of a banner advertisement following user selection of the invention's Back button according to one embodiment of the invention.

FIG. 4C provides an example of a banner advertisement following user selection of the invention's List button according to one embodiment of the invention.

FIG. 4D provides an example of a banner advertisement following user selection of a list item in the invention's list area according to one embodiment of the invention.

FIG. 5A provides an example of a banner advertisement displaying the invention's expanded list feature according to one embodiment of the invention.

FIG. 5B provides an example of a banner advertisement, and the invention's Settings window, following selection of the invention's Settings link according to one embodiment of the invention.

FIG. 5C provides an example of a banner advertisement, and the invention's “Help” window, following selection of the invention's “Help” link according to one embodiment of the invention.

FIG. 6A provides an example of a banner advertisement, and the invention's Search window, following selection of the invention's Search link according to one embodiment of the invention.

FIG. 6B provides an example of a banner advertisement following selection of the invention's Find button within its Search window according to one embodiment of the invention.

FIG. 7 provides a flow-chart diagram of the invention's initialization process according to one embodiment of the invention.

FIG. 8A provides a flow-chart diagram of the invention's processing when selection of its Back button occurs according to one embodiment of the invention.

FIG. 8B provides a flow-chart diagram of the invention's processing when selection of its Next button occurs according to one embodiment of the invention.

FIG. 8C provides a flow-chart diagram of the invention's processing when selection of its List button occurs according to one embodiment of the invention.

FIG. 9A provides a flow-chart diagram of the invention's processing when selection of a list item occurs within its list area according to one embodiment of the invention.

FIG. 9B provides a flow-chart diagram of the invention's processing when selection of its Settings link occurs according to one embodiment of the invention.

FIG. 9C provides a flow-chart diagram of the invention's processing when selection of its Submit button within its Settings window occurs according to one embodiment of the invention.

FIG. 9D provides a flow-chart diagram of the invention's processing when selection of its Help link occurs according to one embodiment of the invention.

FIG. 10A provides a flow-chart diagram of the invention's processing when selection of its Search link occurs according to one embodiment of the invention.

FIG. 10B provides a flow-chart diagram of the invention's processing when selection of its Find button occurs within its Search window according to one embodiment of the invention.

### DETAILED DESCRIPTION OF THE INVENTION

A method and apparatus for providing increased accessibility and effectiveness of advertisements delivered via a network is described. In the following description, numerous specific details are set forth in order to provide a more thorough description of the present invention. It will be apparent, however, to one skilled in the art that the present invention may be practiced without these specific details. In other instances, well-known features have not been described in detail so as not to obscure the invention.

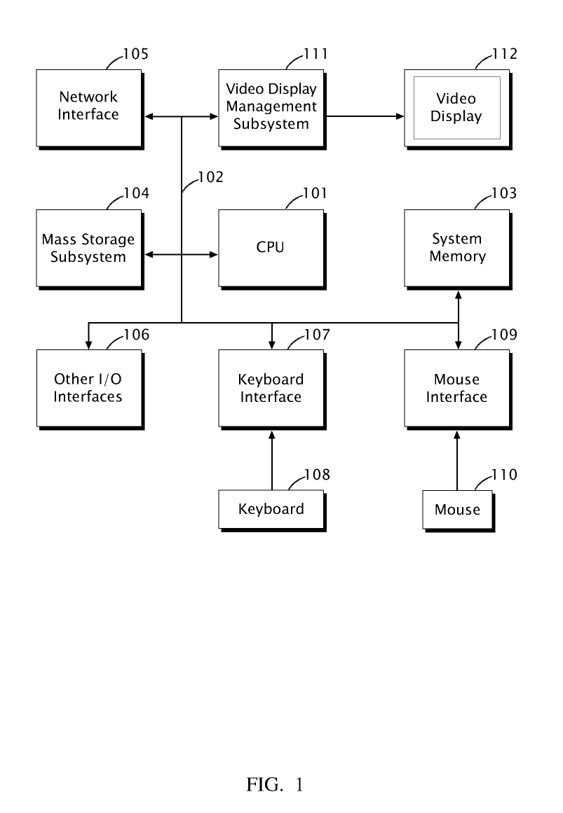

The present invention can be implemented using a general-purpose computer connected to any network system that will permit bi-directional transfer of data between a user's computer and a server computer. Such a general-purpose computer is illustrated in FIG. 1. A keyboard 108 and mouse 110 are coupled via their respective hardware interfaces, 107 and 109, to a bi-directional system bus 102. The keyboard 108 and mouse 110 are used for introducing user input to the computer system for processing by the CPU 101. The bi-directional system bus 102 conveys data, address, and control signals between and among the computer's components, which include the CPU 101, system memory 103, network interface 105, mass storage subsystem 104, video display management subsystem 111, and other I/O interfaces 106. The video display management subsystem 111 stores and converts pixel data into video signals suitable for use by a video display 112 to which it is connected. The video display 112 is used to display data in the form of graphical images to the user of the computer. All of the above components are well known in the art and may be implemented by any suitable means.

In the preferred embodiment of the invention, the CPU 101 is a microprocessor such as a Pentium microprocessor manufactured by Intel. However, any other suitable microprocessor or computing device may be utilized. The system memory 103 is comprised of dynamic random access memory (DRAM). The network interface 105 is a Ethernet-compatible networking device. The mass storage subsystem 104 is implemented using any suitable mass storage technology, such as magnetic or optical systems, and may include both fixed and removable media. The video display 112 is a monitor that uses a liquid crystal display (LCD), or any other display technology that is suitable for displaying graphical images.

The computer system described above is for purposes of example only. The present invention may be implemented in any type of computer system or programming or processing environment including wireless phones, portable Internet communication devices, PDAs, Internet enabled televisions, set-top boxes, and digital video recorders.

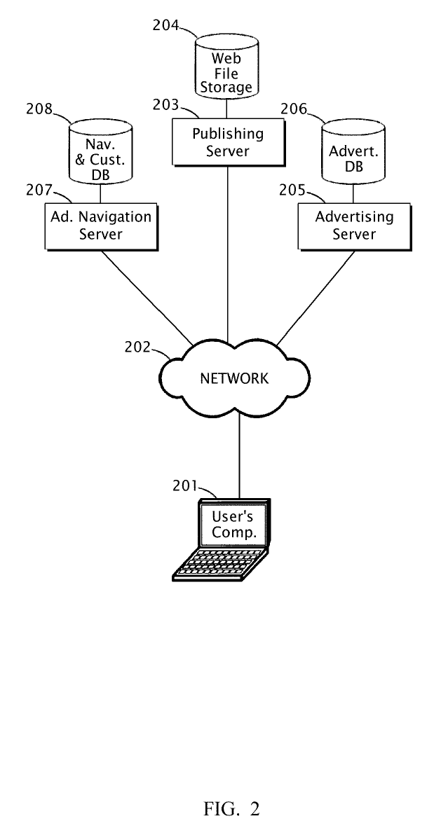

FIG. 2. illustrates the connections between the above described computer system, a network, and three server computers. A computer 201, used by an operator (user) of the present invention, is connected to a network 202 (typically the Internet.) Operation of the present invention is initiated when the user directs a typical web browser application (such as Firefox by The Mozilla Foundation of Mountain View, Calif.) executing in that computer 201 to a web publisher's server 203, and requests a web page containing advertisements that are functionally associated with the invention. That server 203 retrieves the page from its storage subsystem 204 and transfers it to the requesting browser on the user's computer 201. As that web browser loads the received page, items needed for presenting the page's advertisements (image files, animation files, etc.) will typically be requested from an advertising server 205 that retrieves those elements from its advertising database 206 and sends them to the browser (several such advertising servers are often needed to supply a web page's advertising content.) Associated with the advertising elements in that web page, are “operator controls” (interactive GUI components) and programmatic elements that are functioning parts of the invention. These parts of the invention communicate independently, and under user control, with the invention's Ad. Navigation Server 207. That server responds to such communication by storing or retrieving data in its navigation and customer database 208, and by providing additional processing support as needed to serve the functionality of the invention.

Using embodiments of the present invention, the above described operator controls, software, and Ad. Navigation Server operate in conjunction with each other to record a history of Internet advertisements presented to the invention's operator, and to display that history and its associated advertisements to the operator upon demand.

### Software Implementation

In the preferred embodiment of the present invention, the invention's operator controls and software are developed using a programming language that can create interactive elements within the context of a displayed web page. Products commonly used to implement such components are JavaScript (provided under public license by The Mozilla Foundation of Mountain View, Calif.), Flash (produced by Adobe Systems of San Jose, Calif.), Java (produced by Sun Microsystems, Inc. of Mountain View, Calif.), and .NET Framework (produced by Microsoft Corporation of Redmond, Wash.). Such programming products may also be used in combination to produce the invention's operator controls and software. An example of one such combination is AJAX (Asynchronous JavaScript and XML.)

The present invention's Ad. Navigation Server (Nav. Server) is also implemented using software created with any programming language suitable for interaction with the server's standard web server process and database management system. Examples of such languages are the C programming language, C++, Java, and PERL. Examples of database management systems that may be used in the Nav. Server are SQL (Structured Query Language) servers available from a variety of open-source and proprietary sources. Implementation of the Nav. Server may also be accomplished through use of “application server” products designed to facilitate communication between web browser-based software and server-based databases. Examples of such software are IBM's Websphere and Apache's Tomcat.

Operator Controls—Appearance and Location within Web Content

In the preferred embodiment of the present invention, a user directs his or her web browser to a web publisher's server and retrieves a web page containing advertisements that are functionally associated with the invention. Upon loading of that page, the user will clearly observe this functional association in the form of the invention's operator controls on, overlapping, adjacent, or near each of the displayed advertisements. Each operator control is comprised of a “previous” button, a “next” button, and a “list” button. This component permits the invention's user to navigate a history of Internet ads he or she has previously viewed, and to display those ads.

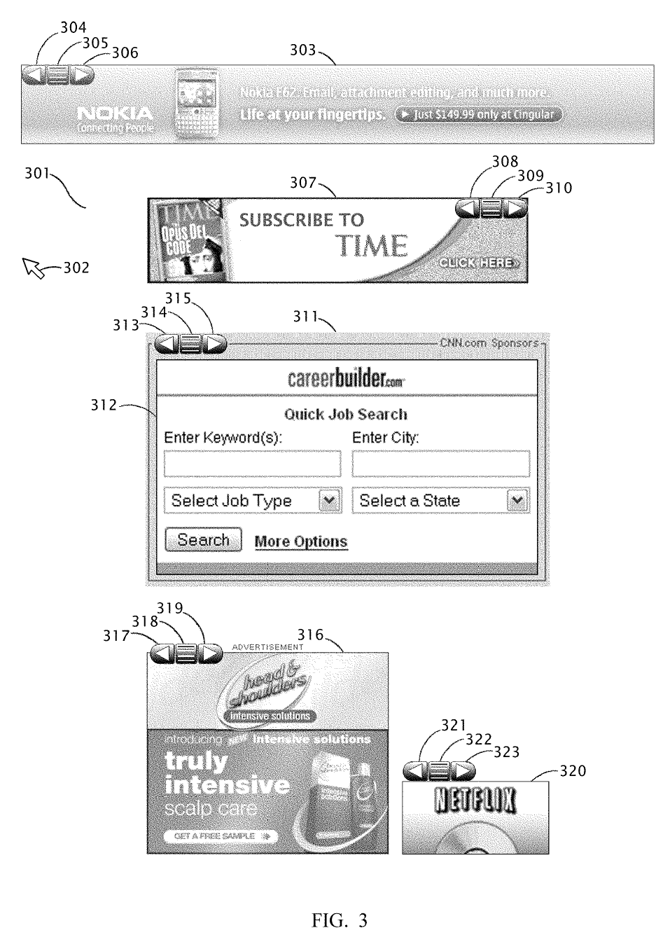

FIG. 3. illustrates examples of typical Internet advertisements with their associatively positioned operator controls as provided by the present invention. Presented in a portion 301 of a web page displayed by a web browser on a computer's display screen, are five advertisements 303, 307, 312, 316, and 320. At the top of that web page portion 301 is a banner ad 303 associated with an operator control comprising a back button 304, list button 305, and next button 306. Out of the possible positions where the invention's operator control may be placed (on, overlapping, adjacent, or near its associated ad), the ad 303 at the top of FIG. 3. shows that component 304, 305, 306 situated “on” its associated ad 303. For purposes of this description, an operator control described as “on” its associated advertisement will mean that it is positioned entirely within the displayed boundaries of its advertisement.

Positioning of the present invention's operator controls in relation to associated ads will typically be chosen by the website publishers who deploy the invention, and occasionally by the graphic designers who produce such ads. Furthermore, website publishers may adjust the component's appearance in regard to color, size, source-image, and transparency to achieve an appealing visual integration into their web pages.

Continuing with FIG. 3., the present invention's operator control, comprising previous, list, and next buttons 308, 309, 310, is shown positioned on an ad 307. In this example, however, the operator control 308, 309, 310 is positioned in the upper-right corner of the ad 307 instead of the upper-left corner as in the previous example. This illustrates how the position of the invention's operator controls may be selected to prevent important graphical content in an advertisement from being obscured.

Continuing with FIG. 3., an example of the present invention's operator control, comprising previous, list, and next buttons 313, 314, 315, is positioned near an ad 312. This example illustrates a type of ad containing HTML form elements that encourage users to enter data and submit a form. Upon submitting such a form, a user is transferred to an advertiser's website to view results based on his or her submitted data, as well as further promotional information. Because website publishers do not wish their users to confuse such form elements with non-advertising content, publishers often indicate the advertising nature of those elements using graphical borders and textual labels. Such a border 311 surrounds the ad 312 in this example. The invention's operator control 313, 314, 315 is shown positioned near the ad 312 and within this border 311.

Continuing with FIG. 3., an example of the present invention's operator control, comprising previous, list, and next buttons 317, 318, 319, is overlapping an ad 316. This positioning of a component can be used to achieve minimal visual interference with an ad's display area, yet indicate clear functional association between the component and the ad.

Continuing with FIG. 3., an example of the present invention's operator control comprising previous, list, and next buttons 321, 322, 323 is positioned adjacent to an ad 320. This component positioning can be used to avoid any visual interference between the component and an ad's display area, and is especially useful for smaller ads.

For all of the examples illustrated in FIG. 3, there is no change in the behavior Internet users expect from the advertisements. When a user moves a cursor 302 into an ad's image using a mouse, and “clicks” the mouse (e.g. initiates a user-selection event), the user's web browser is directed to the website of the ad's associated advertiser.

### Operator Controls—Operational Behavior

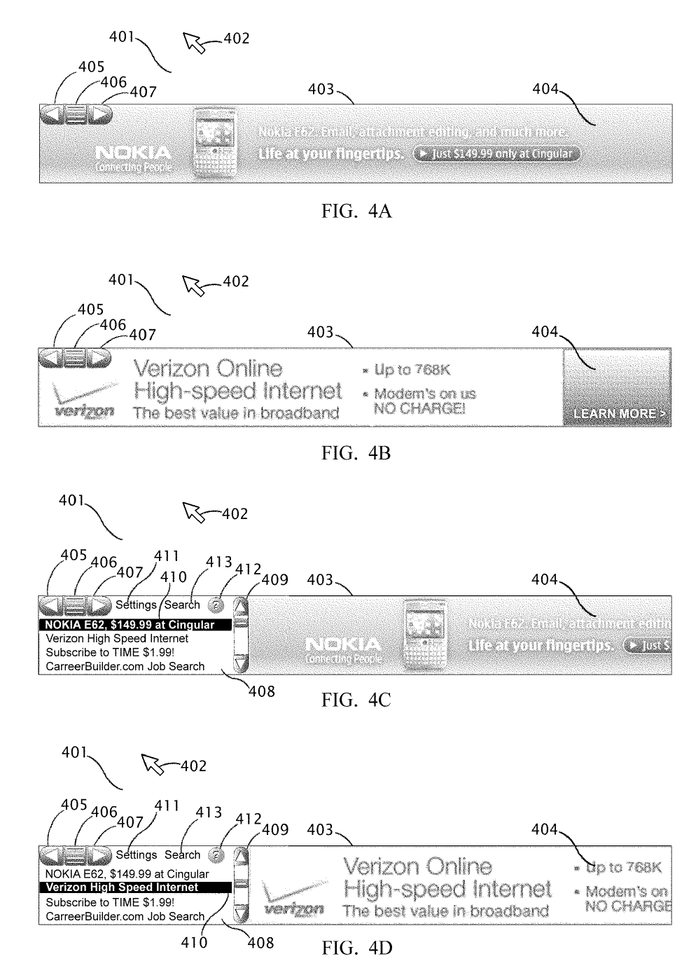

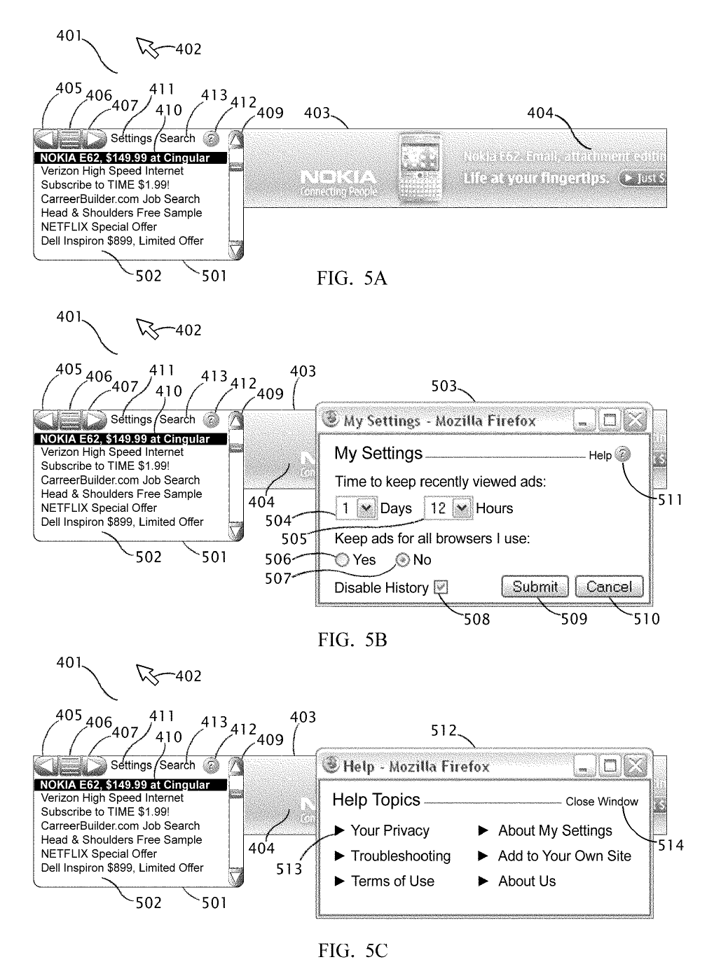

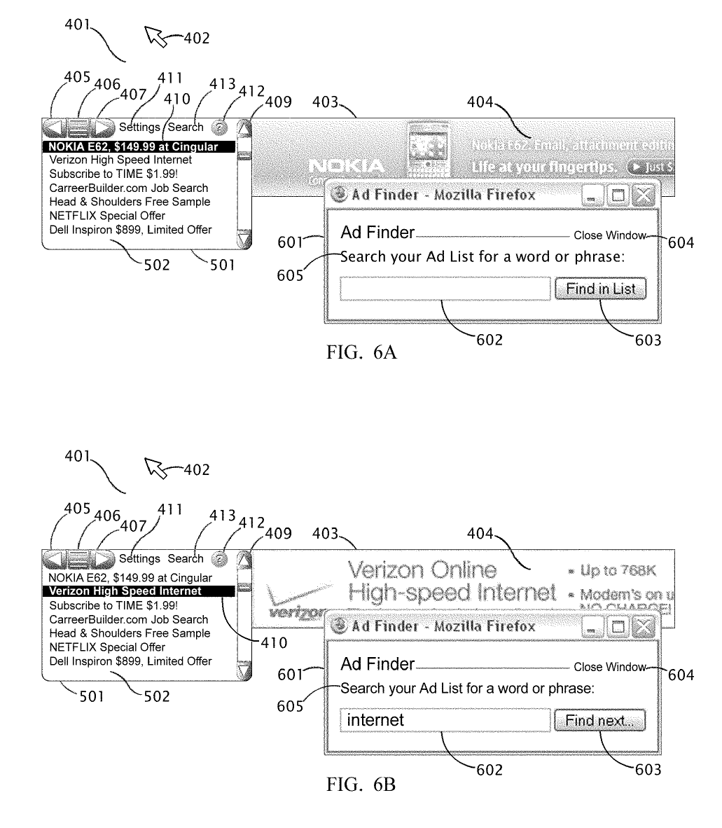

The ensuing discussion describes the operational characteristics of the operator controls provided in the preferred embodiment of the present invention using illustrations provided in FIG. 4A through 4D, FIG. 5A through 5C, and FIG. 6A and 6B.

FIG. 4A illustrates a banner ad 403 presented in a portion 401 of a web page displayed by a web browser on a computer's display screen. The present invention's operator control, comprised of back, list, and next buttons 405, 406, 407, is functionally associated with that ad 403. The display area 404 of that ad 403 presents the advertisement displayed when the web page containing the ad 403 was originally loaded into its browser. Subsequent discussion and illustrations will describe the invention's operations within this ad's display area 404 in response to a user's operation of a mouse and cursor 402.

FIG. 4B illustrates the present invention's response to its user clicking the invention's back button 405 using a mouse and cursor 402 when a banner ad 403 is in the state illustrated in FIG. 4A. In FIG. 4B, the display area 404 of the ad 403 has been changed to present an advertisement previously viewed by the invention's user. Thus, selection of the back button 405 has caused the invention to step chronologically backward through its history of displayed ads. By default, the invention presents such previously viewed ads at their original sizes. When an ad's height or width exceeds either of those dimensions for the display area in which it will be presented, the invention scales the ad to fit the display area.

Continuing with FIG. 4B, if the user clicks the present invention's next button 407 using a mouse and cursor 402, the invention will reload the ad that was presented in the display area 404 when the ad was originally loaded. Thus, selection of the next button 407 has caused the invention to move chronologically forward through its history of displayed ads, and returned its associated ad 403 to the state illustrated in FIG. 4A.

FIG. 4C illustrates the result of a user clicking the present invention's list button 406 using a mouse and cursor 402 when the ad 403 is in the state illustrated in FIG. 4A. In FIG. 4C, the invention's list area 408 has been presented in a portion of that ad's display area 404. The list area 408 is used to display the invention's “list items” (textual descriptions associated with previously viewed ads), as well as provide a “Settings” item 411, “Search” item 413, and a “Help” item 412. The advertisement that was in the ad's display area 404 when the list button 406 was selected is offset to the right of the invention's list area 408 and separated from it by a scrollbar 409. A scrollbar is a GUI element well known in the art, and is used by the present invention to permit users to view a large number of list items within the limited space of the invention's list area 408. The list area's highlight bar 410 always highlights the list item corresponding to the advertisement currently viewed in the remaining portion of the display area 404.

FIG. 4D illustrates the result of a user clicking a list item in the present invention's list area 408 using a mouse and cursor 402 when the ad 403 is in the state illustrated in FIG. 4C. In FIG. 4D, the second list item in the list area 408 has been selected and the invention has loaded its corresponding ad into the right portion of the ad's display area 404. The invention has also positioned its highlight bar 410 on the second list item in the list area 408 to indicate the advertisement currently displayed.

FIG. 5A illustrates the present invention's “expanded list” option. When this option is enabled, the invention's list area may extend below its associated banner ad, thereby reducing a user's reliance on the invention's scrollbar when browsing long lists. Furthermore, when the invention is operated with smaller ads, the extended list area can be positioned so that it minimally obscures, or is entirely outside, an ad's display area. FIG. 5A shows a banner ad 403 following selection of the invention's list button 406. In this example, the invention's expanded list 501 extends below the display area 404 of the ad 403. The expanded list 501 contains the invention's list area 502 showing the list items illustrated in FIG. 4C and 4D, as well as additional list items below them. Were the expanded list option disabled, as in the examples shown in FIG. 4C and 4D, a user would need to advance the invention's scrollbar 409 to view such additional list items. The length of the invention's scrollbar is always extended to fit the height of its expanded list's display area.

FIG. 5B illustrates the result of a user clicking the “Settings” item 411 in the present invention's list area 502 using a mouse and cursor 402. The invention responds to this action by causing the web browser in which it operates to launch a small browser window 503. This “Settings” window 503 displays a web page containing HTML form elements that permit a user to view and change the invention's operational settings for that user. Among these elements is a pair of “drop-down” lists 504, 505 used to define a historical range over which a user's previously viewed ads will be maintained. A pair of “radio buttons” 506, 507 are used to configure the invention so that it can record its user's ad history when the user operates multiple web browsers. For example, a user viewing ads on a web browser at his or her workplace may also wish to view those ads when browsing the Internet at home. Below the radio buttons 506, 507 is a “check box” 508 that permits a user to disable the invention's recording of advertising history and cause all recorded ad history to be discarded. The remaining form elements contained in the Settings window 503 are the “Submit” 509 and “Cancel” 510 buttons. The Submit button 509 is used to store a user's changes to the form. The Cancel button 510 dismisses the form and window 503 without storing changes. A final item displayed in the Settings window 503 is the “Help” item 511. This item is a hyperlink that loads, within the Settings window 503, a web page containing information to assist a user specifically with the invention's operational settings.

The above description provides several examples out of many possible configuration features that can be provided to users of the present invention, and should not be interpreted as limiting the invention only to those examples.

FIG. 5C illustrates the result of a user clicking the “Help” item 412 in the present invention's list area 502 using a mouse and cursor 402. The invention responds to this action by causing the web browser in which it operates to launch a small browser window 512. This “Help” window 512 displays a web page containing hyperlinks to additional web pages that can be loaded into the Help window 512. The “Your Privacy” bulleted item 513 is an example of one such hyperlink. The additional web pages provide the invention's user with general information about the invention and assistance with its operation. The Help window 512 also contains a “Close Window” hyperlink 514 that executes a JavaScript function to close the Help window 512.

FIG. 6A illustrates the result of a user clicking the “Search” item 413 in the present invention's list area 502 using a mouse and cursor 402. The invention responds to this action by causing the web browser in which it operates to launch a small browser window 601. This “Search” window 601 displays a web page containing HTML form elements comprising a “text-entry field” 602 and a button 603 labeled “Find in List.” These elements enable the invention's user to search for specific words or phrases within the list items in the invention's list area 502. The Search window 601 also contains a “prompt area” 605 providing textual information to the invention's user, and a “Close Window” hyperlink 604 that executes a JavaScript function to close the Search window 601.

FIG. 6B illustrates the result of a user entering a search term into the text-entry field 602 of the present invention's Search window 601, and clicking its associated button 603 using a mouse and cursor 402. In the example in FIG. 6B, the invention has located a list item containing the user's search term and positioned its highlight 410 on that item within its expanded list area 502. The invention has also loaded that item's corresponding ad image into the right portion of the ad's display area 404. The button 603 used to initiate the search has been relabeled “Find next . . . ” by the invention. This is done to instruct the user that he or she may again click that button 603 to search the list of list items for additional occurrences of the search term in the text-entry field 602. If a user begins typing a new search term into the text-entry field 602, that button 603 would be relabeled “Find in List” by the invention. This is done to affirm to the user that the newly typed text in the text-entry field 602 will be processed as a new search operation. In the event no occurrences of a user's search term are found, the text in the prompt area 605 will be changed by the invention to indicate that condition to the user.

Although the above description of the present invention's Settings, Search, and Help features refer to illustrations showing the invention's expanded-list option enabled, all of those features will operate as described when that option is disabled.

### Preferred Embodiment—Logic and Event Processing

Client-side logic and event processing within the preferred embodiment of the present invention is accomplished using JavaScript and its manipulation of the standard “Document Object Model” (DOM) as specified by the World Wide Web Consortium (W3C). This international standard for querying and modifying web page content is well known in the art, and is well supported in recent versions of all popular web browsers (Microsoft Internet Explorer, Firefox, Opera, Mozilla, Safari, etc.) The invention also uses the W3C's “Cascading Style Sheets” (CSS) standard to define the styles and positions of its web page elements. In the preferred embodiment of the invention, communication between the invention's JavaScript functions and its Nav. Server is accomplished using a small Java applet as an intermediary communications service. In other embodiments of the invention, the invention's JavaScript functions may instead use the DOM “XMLHttpRequest( )” object and route such communication through the server that supplied its web page (a standard AJAX communications technique.)

The software code used to implement the preferred embodiment of the present invention resides within web pages as JavaScript functions and CSS style sheets, in library files as collections of JavaScript functions, in compiled Java applet files, and in executable code files in the invention's Nav. Server. The invention also relies on well-known features and behavior of typical web browsers and web servers.

### Preparation of Web Documents and Advertisements

A website publisher seeking to provide the preferred embodiment of the present invention within a web page, must include the invention's client software components in the page's source file (e.g. HTML file), as well as specific metadata identifiers to identify advertising data elements within the page. The preparation is performed per the following steps:
(a) The invention's JavaScript code and its Java applet's HTML tags are added to the page. The applet's HTML uses the “<OBJECT>” tag with a unique “ID” parameter so the applet can be accessed by the invention's JavaScript code using the DOM.
(b) For each advertisement within the web page, HTML division tags (the “<DIV>” and “</DIV>” tags used to define a DOM accessible portion of a web page) are added to enclose the advertising data element (e.g. the portion of HTML code that provides the advertisement.) The enclosing DIV tags serve as metadata identifiers that enable the invention's software to locate and modify the advertising data element and provide it with an associatively positioned instance of the invention's operator control.
(c) A unique ID parameter is assigned to each of the <DIV> tags added in step (b). A first, fixed-length portion of the text string assigned to each ID will provide a “group-id” that identifies the division as part of a unique group of divisions with which the invention can interact (for example, the string “adNav” may be assigned to the beginning of the ID strings of all such divisions.) The group-id is followed by configuration data used by the present invention to control the presentation characteristics of the operator control associated with that ID's division. Such characteristics may include that control's position (e.g. on, overlapping, adjacent, or near an advertisement), as well as its color, size, source-image, and transparency. The remainder of the ID string will be a substring chosen to insure the uniqueness of the ID within the DOM. Typically, that substring will be the identification code used in its division's enclosed HTML code to retrieve specific ad content from an Ad. server. The string “adNav-ABCD1234-12345” is an example of a complete ID string comprising a group-id (“adNav”), configuration data (“-ABCD1234-”), and an ad's unique identification code (“12345”).
(d) An HTML comment (e.g. text enclosed by HTML “<!--” and “-->” tags) is inserted as the first line of the division-enclosed HTML code. This comment provides a brief textual description of the division's associated advertisement. That description will later be used to represent the advertisement as a list item in the list area presented by the invention's operator control. This HTML comment serves as an additional metadata identifier assigned to the advertising data element.

The above steps enable the present invention to locate advertisements within a web page, create and position its operator controls at each ad location, capture and store HTML code that presents each ad, and obtain identification of the ad for tracking purposes. This preparation is required for any page intended for use with the preferred embodiment of the present invention.

In other embodiments of the invention, such as software applications that present embedded Internet advertising, the present invention's software components can be made part of the software code of a host application. In that case, inclusion of software components as described in step (a), above, will be omitted and only metadata identifiers will be included and configured within the source file.

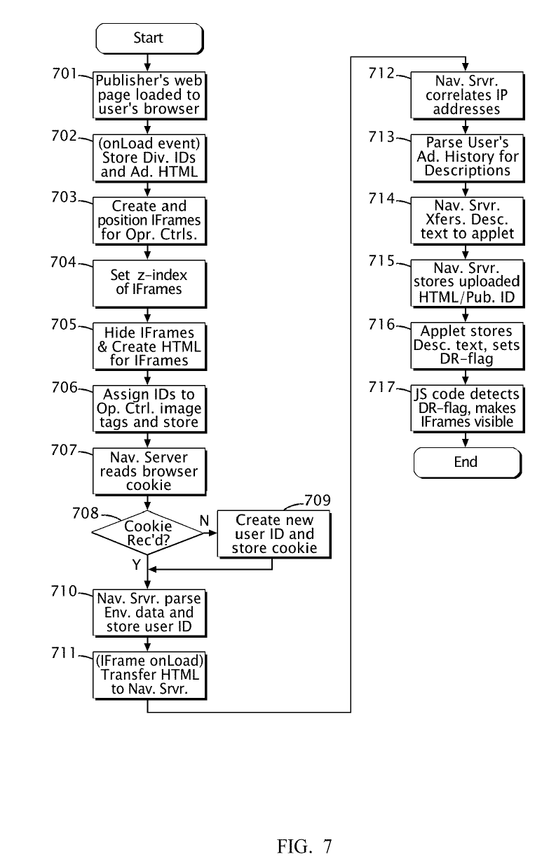

### FIG. 7—Initialization

FIG. 7 provides a flowchart that illustrates the present invention's initialization operations. A user retrieves a web page from a publisher's web server using a web browser application operating on a personal computer 701. When that web page has completed loading into its web browser, the standard JavaScript “onLoad” event is propagated to all JavaScript functions observing it in that page. The onLoad event indicates that all web page content has been received. The present invention's “ad-finder software” (implemented in JavaScript code) receives that onLoad event and searches the web page's DOM for the ID properties of HTML divisions enclosing the page's advertisements. These HTML divisions and their IDs have been assigned and configured by the web page's publisher per the steps described above (See: “Preparation of Web Documents and Advertisements”.) For each of those divisions, the ad-finder software stores the division's ID string, then uses the division's “innerHTML” property within the DOM to capture and store the HTML between the division's <DIV> and </DIV> tags 702.

Continuing with FIG. 7, when all of the divisions' IDs and advertising HTML have been stored by the invention's ad-finder software as described above, control is passed to the invention's “control-assignment software” (implemented in JavaScript code) that dynamically creates floating HTML IFrame elements to contain each of the invention's operator controls within the page. Such IFrames designate content regions within web pages and are typically used to present other web pages within their bounds. IFrames created for the invention's operator controls are assigned unique DOM IDs that are also stored in memory in a manner that references them to their associated divisions (e.g. HTML divisions that enclose advertising HTML, as described above.) The IFrames created for the operator controls are then dynamically positioned by the control-assignment software to be relative to those divisions 703. This positioning is accomplished by retrieving the position and size properties of those divisions (via DOM access), and then calculating relative positions for those IFrames using the configuration data supplied in the divisions' ID parameters (See: “Preparation of Web Documents and Advertisements”, above.) The control-assignment software also sets the “z-index” of those IFrames to make them topmost of the web page elements they overlap 704. The control-assignment software accomplishes this by using the DOM to retrieve the z-index values of divisions associated with those IFrames, and the z-index values of any containment elements (e.g. other divisions or IFrames) that may contain those divisions. Thus, the invention's operator controls will not be obscured by their associated advertisements or other page elements.

Continuing with FIG. 7, after the control-assignment software creates IFrames for its operator controls as described above, it configures each IFrame to be “hidden” (e.g. not displayed) and sized to fit the operator control. That software then dynamically generates and assigns HTML code to be presented within those IFrames 705. Within each IFrame's HTML code are CSS defined divisions containing HTML tags for the invention's list area elements (e.g. scrollbar, advertisement description list, and the Settings, Search, and Help links), as well as a division containing image tags for the button images appearing in its operator control. All of these tags are configured to call JavaScript functions within the invention's “ad-navigation software” in response to user-selection events (e.g. mouse events) 706. When such an event occurs, the called function uses the “parentlD” access method within the DOM to determine which IFrame contains the element sending the event. Thus, the invention may respond to mouse events within those elements as user input to a specific operator control.

Continuing with FIG. 7, after the control-assignment software has completed assignment of HTML to its IFrames as described above, its web browser will automatically request the images for those IFrames from the invention's Nav. Server. That connection to the Nav. Server fulfills the web browser's security requirement regarding retrieval of browser cookies (typical web browsers restrict cookie retrieval only to servers supplying content for a currently viewed web page.) The invention's “ad-storage software” operating in the Nav. Server then attempts to read a browser cookie from the user's web browser 707. That cookie will contain an alphanumeric string uniquely identifying that browser's user. If the cookie is not present in the user's browser 708, the ad-storage software will generate a new cookie containing a randomly generated user-id code and store it using the user's browser 709.

Continuing with FIG. 7, the present invention's ad-storage software parses the environment-data supplied by the Nav. Server's HTTP server process when images for the IFrames described above are requested. This data contains the IP (Internet protocol) address of the requesting web browser, and other information used by the ad-storage software for managing interaction between itself and the invention's software within that browser. The ad-storage software then associates the IP address of the requesting browser with the user-id code provided in the cookie described above, and stores that information for a predetermined period of time 710.

Continuing with FIG. 7, when HTML is assigned to the present invention's IFrames as described above, one of those IFrames is assigned the JavaScript onLoad parameter in its HTML “<BODY>” tag. That IFrame's onLoad event will be evoked when its web browser completes loading all of the IFrame's images (e.g. button images for the operator controls described above.) The event handler specified by that onLoad parameter is a function within the invention's ad-finder software. When that function is called, the ad-finder software uses the DOM to access the invention's Java applet within its web page. That applet is used to provide communications between the invention's browser-based client processes and the invention's server-based processes. Because the applet is retrieved from the invention's Nav. Server, it fulfills a standard security requirement for Internet connections using applets; an “unsigned” applet may only connect to a server from which it was loaded. After accessing the invention's applet, the ad-finder software uses the applet to transmit its stored HTML of the page's advertisements to the Nav. Server. The ad-finder software also transmits a text string uniquely identifying the publisher of its web page 711. After passing the above-described HTML and publisher's ID to the invention's Java applet, the ad-finder software executes a polling-loop to periodically test the applet's “data-received” flag. This flag will be set following the applet's data-exchange with the invention's Nav. Server.

Continuing with FIG. 7, when the present invention's Nav. Server receives the transmitted data as described above, the ad-storage software correlates the source IP address for that data with the source IP address of the cookie retrieved earlier from the same web browser 712. The data within that cookie provides the invention with the ID of the invention's user. The invention uses that ID to access its user's ad-viewing history within the Nav. Server's database.

Continuing with FIG. 7, after the present invention's ad-storage software has added the newly received HTML and publisher's ID to a user's ad-viewing history as described above, the ad-storage software then retrieves that user's entire ad-viewing history from its database and parses each advertisement's HTML for its beginning HTML comment tag 713. These tags provide the textual descriptions displayed to that user when he or she accesses the invention's history list using its operator control (See: “Preparation of Web Documents and Advertisements”, above.) When all textual descriptions have been retrieved, the ad-storage software transmits them to the invention's Java applet in the chronological order in which they were stored in the Nav. Server's database 714.

In addition to providing descriptions for the invention's list area, the transmitted group of textual descriptions serves as the invention's “ad-history element.” In all embodiments of the invention, data comprising an ad-history element is passed from the Nav. Server to the client computer so that the total number of advertisements stored for a specific user can be determined by the invention's client-based software. In the case of the preferred embodiment of the invention, the number of transmitted textual descriptions provides this value. In other embodiments of the invention, the value may be passed as an integer value or a collection of other data items that may be totaled.

Continuing with FIG. 7, the advertising data elements (HTML of advertisements) received by the Nav. Server from the invention's applet, as well as the ID of the publisher of the page presenting those ads, are added to the user's ad-viewing history within the Nav. Server's database by the ad-storage software 715. However, any advertising data elements that duplicate existing advertising data elements within the ad-viewing history will not be added. This prevents a web browser's refresh function, or a user's frequent viewing of the invention's web page, from causing duplicate advertisements to be stored.

Continuing with FIG. 7, when the present invention's Java applet has received all of the textual descriptions of advertisements from its Nav. Server as described above, the applet stores them in a DOM accessible array and sets its data-received flag 716. Upon detecting the applet's data received flag via its above-described polling-loop, the ad-finder software configures all of the dynamically created IFrames to be visible 717. Once visible, the IFrames display their operator controls to the invention's user at each advertising location, and permit user-selection events to be handled by the invention's “ad-navigation” software.

### History Array and Index

The array of advertisement descriptions retrieved by the invention's Java applet, as described above, provides a chronologically organized list representing a user's previously viewed advertisements (the invention's “history array”.) HTML of advertisements originally displayed at the time of a page's loading are stored in memory during the invention's initialization as described above. The invention maintains a memory variable acting as an index into the invention's history array (the invention's “history index”.) The array position pointed to by that index refers to the advertisement currently displayed by the invention.

As a user interacts with the invention's operator control, the invention's “ad-navigation” software references and modifies the history index to determine the currently displayed ad, and determine which ad the invention must display. When a previously viewed ad must be displayed, the ad-navigation software positions its history index at the array position for that ad, requests the ad from the invention's Nav. Server, and uses the invention's “ad-replacement” software to dynamically load that ad's HTML into the appropriate division within its web page.

The ad-navigation software requests an ad by transmitting an “ad-selection element” to the Nav. Server using the invention's Java applet. The ad-selection element is typically the value of the history index. The invention's “ad-retrieval” software executing in the Nav. Server matches the source IP address of that request to the IP address recorded during the invention's initialization to determine the user for whom the request is made. The ad-retrieval software then accesses that user's database records to retrieve the advertisement corresponding to the value of the ad-selection element (the ad's ordinal position within a chronologically organized sequence of that user's previously-viewed advertisements.) The ad-retrieval software then transmits the HTML of the retrieved advertisement to the invention's Java applet, which then makes it accessible to the ad-replacement software.

In the preferred embodiment of the invention, the history-index is incremented to step chronologically backward through the history-array, and decremented to step forward. However, such increment and decrement software functions may be implemented in other embodiments of the invention with chronological orientations that are the opposite of the preferred embodiment. In all embodiments of the invention, however, the resulting operational logic of the invention will be consistent and produce equivalent results; the back button will always cause the invention to step backward chronologically through previously viewed ads and the next button will step forward.

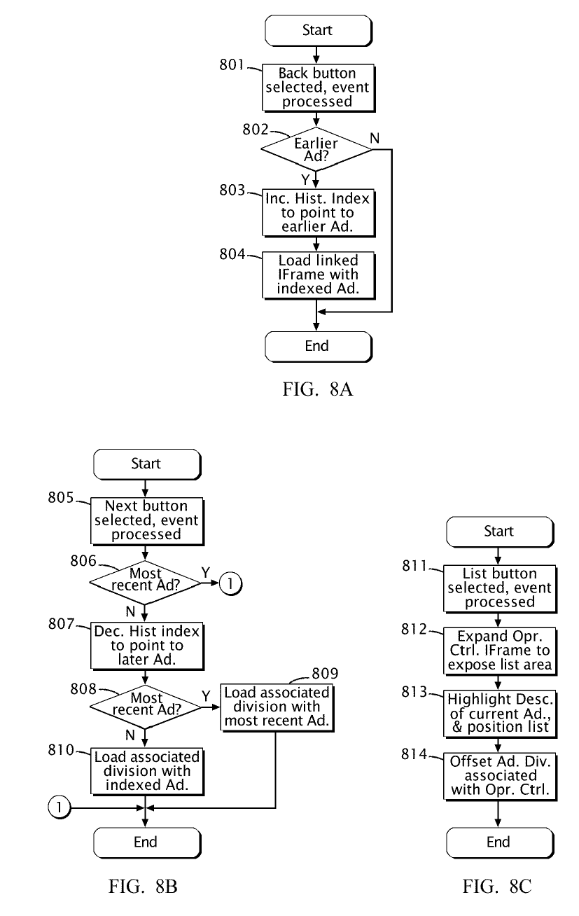

### FIG. 8A—Event Processing for the Back Button

FIG. 8A provides a flowchart that illustrates event processing for the back button provided in the preferred embodiment of the present invention. When a user clicks the back button image on the invention's operator control, the ad-navigation software processes the resulting user-selection event 801. That software accesses the DOM parent elements containing the image to determine which IFrame and HTML division are associated with that operator control. The ad-navigation software then accesses the image's filename to determine the type of button clicked (for example, a filename of “back.jpg” may signify the back button.) Then, the advertisement currently displayed at that ad's page location is determined by the ad-navigation software's referencing of the invention's history index. The ad-navigation software's further processing of the event is as follows:
(a) If there is no array element in the invention's history array after the element pointed to by its history index 802, that function will simply exit. In that case, there is no previously viewed advertisement in the invention's database earlier than the currently displayed ad.
(b) If the history array does contain an element after the indexed element, the function will increment the invention's history index to point to that next element 803. The ad-replacement software is then called to load that ad's HTML into the division associated with the selected back button (See: “History Array and Index”, above) 804.

### FIG. 8B—Event Processing for the Next Button

FIG. 8B provides a flowchart that illustrates event processing for the “next” button provided in the preferred embodiment of the present invention. When a user clicks the next button image on the invention's operator control, the ad-navigation software processes the resulting user-selection event 805. That ad-navigation software determines the event's associated IFrame, HTML division, button type, and currently displayed ad as described above (See: “Event Processing for the Back Button”.) The ad-navigation software's further processing of the event is as follows:
(a) If the ad-navigation software determines the invention's history index has a value of “−1” 806, the event handler function will simply exit. In that case, the −1 value indicates the division associated with the user-selection event contains the advertisement presented at the time of page loading, and therefore the most recent ad for that page location.
(b) If the ad-navigation software determines the history index is not “−1”, the ad-navigation software will decrement the invention's history index 807.
(c) If the value of the index decremented in step (b) is “−1” 808, the ad-navigation software will load, from memory, the advertisement presented at the time of page loading into the division associated with the user-selection event (See: “History Array and Index”) 809.
(d) If the value of the index decremented in step (b) is not “−1”, the ad-navigation software will initiate loading of the HTML of the ad referenced by the array element into the division associated with the user-selection event as described above (See: “History Array and Index”) 810.

### FIG. 8C—Event Processing for the List Button

FIG. 8C provides a flowchart that illustrates event processing for the “list” button provided in the preferred embodiment of the present invention. When a user clicks the list button image on the invention's operator control, the invention's ad-navigation software processes the resulting user-selection event 811. That software determines the event's associated IFrame, HTML division, button type, and currently displayed ad as described above (See: “Event Processing for the Back Button”.) The ad-navigation software then exposes the invention's list area by expanding the size of the event's associated IFrame 812. Within the list items in that area, the ad-navigation software highlights the list item associated with the currently displayed advertisement 813. That highlight is accomplished by modifying attributes of that item's HTML division and text using the DOM. The ad-navigation software then vertically positions the list of list items so the highlighted list item will be within the visible portion of the list area. The list area's scrollbar is then updated by that function to reference the displayed portion of the description list. The ad-navigation software then uses the DOM to modify the size and position of the division containing the currently displayed ad so that the ad appears cropped and offset to the right of the invention's list area (FIG. 4C provides an illustration of such an ad) 814.

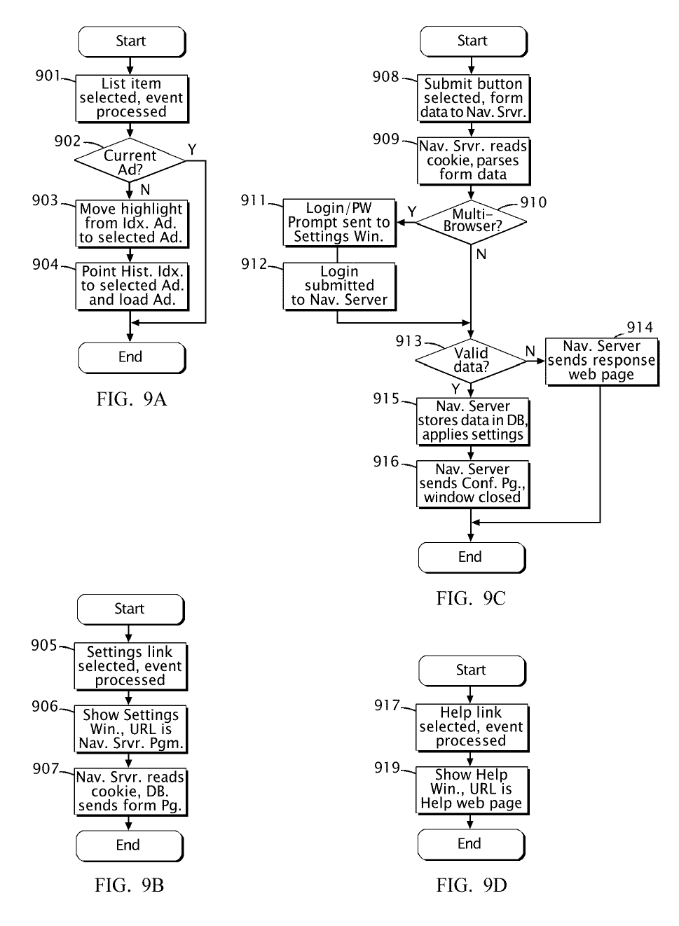

### FIG. 9A—Event Processing for a List Item

FIG. 9A provides a flowchart that illustrates event processing for a list item within the list area provided in the preferred embodiment of the present invention. When a user clicks on a list item within the invention's list area, the invention's ad-navigation software processes the resulting user-selection event 901. That software determines the event's associated IFrame, HTML division, list item, and currently displayed ad as described above (See: “Event Processing for the Back Button”.) The ad-navigation software's processing of the event is as follows:
(a) If the selected list item references the element in the invention's history array pointed to by its history index (the element referencing the currently viewed advertisement) 902, the event-processing function will simply exit.
(b) If the selected list item does not reference the array element pointed to by the history index, the ad-navigation software will modify the HTML division of the highlighted list item so that it is no longer highlighted. The software then modifies the division of the selected list item so that it is highlighted 903, and modifies the invention's history index to point to the element referencing the selected list item. Finally, the ad-navigation software loads the HTML of that element's referenced ad into the division associated with the user-selection event as described above (See: “History Array and Index”) 904.

### FIG. 9B—Event Processing for the Settings Link

FIG. 9B provides a flowchart that illustrates event processing for the “Settings” item within the list area provided in the preferred embodiment of the present invention. When a user clicks the Settings item within the invention's list area, the invention's ad-navigation software processes the resulting user-selection event 905. That software determines the event's associated IFrame and HTML division as described above (See: “Event Processing for the Back Button”), then launches a small web browser window (e.g. the “Settings window”) with a URL specifying a program (e.g. “common gateway interface” application or web service process) in the invention's Nav. Server 906. That program reads the browser cookie containing the ID of the invention's user from the requesting web browser. The program then uses that ID to retrieve the user's existing operational settings from its database. Those settings are then applied as preset values for HTML form elements included in a web page generated by that program. The Nav. Server then transmits that web page to the above-described browser window 907, which displays it as illustrated in FIG. 5B.

### FIG. 9C—Event Processing for the Submit Button (Settings Window)

FIG. 9C provides a flowchart that illustrates event processing for the “Submit” button within the Settings window provided in the preferred embodiment of the present invention. Event handling for the Submit button is managed entirely by the web browser application providing the Settings window. When a user of the invention selects the Submit button within that window, the standard form data within that window is transferred to “settings-management” software in the invention's Nav. Server 908. That software reads the browser cookie containing the ID of the invention's user from the requesting web browser. The settings-management software then parses the form data to determine the requested settings changes 909. If the submitted form includes the selected form element for multi-browser operation 910, that program will generate a web page containing a “login/password” form and send it to the requesting browser window (e.g. the Settings window) 911. A user may then submit the login/password form for validation by the settings-management software 912.

Successful submission of the login/password form enables a user to maintain his or her ad history across multiple web browsers. In that case, the settings-management software in the Nav. Server associates and stores the user-supplied login and password with the user-id code stored in a browser cookie in the user's web browser. If a user then submits the same login and password when using the invention in web browsers on other computers, the invention will store the same user-id code in browser cookies for those web browsers. The invention will then store advertisements collected from those browsers in database records for that user-id code within its Nav. Server. Thus, the user's previously viewed ads may be collected and accessed at any web browser operated by the user.

Continuing with FIG. 9C, if the settings-management software validates the form data and/or the login/password data 913, the software will associate the user's ID code with the new settings and store them in its database. In the case of login/password data submitted for an existing multi-browser configuration, the settings-management software will transmit a browser cookie as described above and consolidate ads stored for the currently viewed web page into the database records for the validated user-id code. All validated settings will then be applied to the invention's future interaction with that user 915. The settings-management software then transmits a simple confirmation web page to the invention's Settings window to inform the user that his or her desired settings were applied by the invention 916. If the submitted form data and/or the login/password data are found to be invalid, a response web page will be transmitted to the Settings window indicating the validation error 914.

### FIG. 9D—Event Processing for the Help Link

FIG. 9D provides a flowchart that illustrates event processing for the “Help” item within the list area provided in the preferred embodiment of the present invention. When a user clicks the Help item within the invention's list area, the invention's ad-navigation software processes the resulting user-selection event 914. That software determines the event's associated IFrame and HTML division as described above (See: “Event Processing for the Back Button”), then launches a small web browser window (e.g. the “Help window”) with a URL specifying a web page stored on the invention's Nav. Server 915. Event processing within that window is managed entirely by its web browser application as a typical web page. That page contains hyperlinks to additional web pages on the Nav. Server that can be loaded into the Help window. Those pages provide the invention's user with general information about the invention and assistance with its operation. That window also contains a hyperlink that executes the standard JavaScript function to close the window.

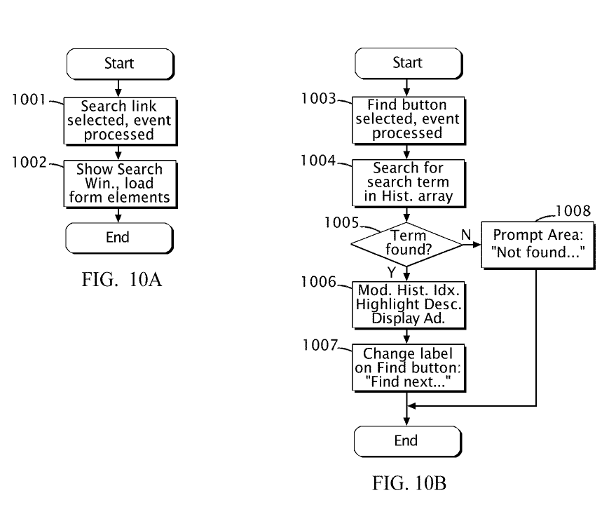

### FIG. 10A—Event Processing for the Search Link

FIG. 10A provides a flowchart that illustrates event processing for the “Search” item within the list area provided in the preferred embodiment of the present invention. When a user clicks the Settings item within the invention's list area, the invention's ad-navigation software processes the resulting user-selection event 1001. That software determines the event's associated IFrame and HTML division as described above (See: “Event Processing for the Back Button”), then launches a small web browser window (e.g. the invention's “Search window”) near that HTML division. The ad-navigation software accesses that window using the DOM and dynamically loads HTML text and form elements into it 1002. Those elements, comprised of a text-entry field, a “Find button”, and a “prompt area”, provide users with means to search for user-supplied words and phrases within the description text stored in the invention's history array. The invention's Search window also contains a hyperlink that executes the standard JavaScript function to close the window.

### FIG. 10B—Event Processing for the Find Button (Search Window)

FIG. 10B provides a flowchart that illustrates event processing for the Find button within the within the Search window provided in the preferred embodiment of the present invention. When a user enters a “search term” (e.g. words or phrases used as criteria for a query) into the Search window's text entry field, and then clicks the window's Find button, the button will pass the resulting event to an event handler function specified in the button's HTML tag 1003. That function is part of the invention's ad-navigation software. Beginning with the history array element following the element pointed to by the history index, the ad-navigation software will attempt to locate a description that contains text matching the user-supplied search term 1004. If an element in that array contains the search term 1005, the ad-navigation software will modify the invention's history index to point to that element, highlight its referenced description within the invention's list area, and display the description's associated ad as described above (See: “Event Processing for a List Item”) 1006. The ad-navigation software will then access the “label” attribute of the invention's Find button using the DOM and change it's text from “Find” to “Find Next . . . ” 1007 This is done to suggest to the invention's user that an additional click on the Find button will advance his or her search (using the same search term) through the remainder of the list of descriptions. Thus, that user may view all advertisements related to his or her search term. If the ad-navigation software is unable to find matching text within the invention's history array, the software will modify the text of the prompt area within the invention's Search window to indicate that no occurrence of the search term was found 1008. If the invention's Find button is clicked after its event handler function has searched the entire history array, that function will begin searching from the first element in the array.

The preferred embodiment of the present invention can be considered part of a class of software applications commonly referred to in the art as “web services” (e.g. server-delivered applications that provide their functionality to users via web browsers.) In the above discussion, well-known features common to such services have not been described so as not to obscure the invention. Examples of such features are software functions that analyze web browser types and versions in order to compensate for browser-idiosyncrasies, and enhancements for security and data integrity. However, one skilled in the art will understand that these and other well-known features will typically be provided in embodiments of the present invention, as they would be for other such web services.

Thus, a method and apparatus for providing increased accessibility and effectiveness of advertisements delivered via a network has been described.

I claim:

1. A method for increasing the accessibility and effectiveness of advertisements delivered via a network comprising the steps of:
(a) including metadata identifiers in a source file that is computer readable, and contains one or more advertising data elements, wherein each advertising data element is assigned a unique set of one or more metadata identifiers;
(b) retrieving the data contained in said source file from a first server computer using a network in conjunction with a viewing software application executing in a user's computer, and automatically processing the retrieved data to provide an interactive presentation that is viewable using a display device operatively connected to said user's computer, wherein advertisements, derived from said advertising data elements, are displayed as part of said interactive presentation, and said interactive presentation can retrieve and display items specified in said source file as requiring retrieval from one or more server computers;
(c) automatically determining the locations of advertisements displayed within said interactive presentation by finding and accessing the positional information of said metadata identifiers therein, and dynamically generating and displaying interactive operator controls at predetermined offsets relative to the determined locations of the advertisements, such that each advertisement within said interactive presentation is provided an associatively positioned interactive operator control, wherein each interactive operator control is provided a plurality of predetermined portions that are individually responsive to user-generated selection events;
(d) automatically transmitting, from said user's computer to a second server computer using said network, data comprising said advertising data elements and a user-identification code that is predetermined;
(e) automatically querying a database, accessible to said second server computer, to provide a result-set comprising data-records that are associated with said user-identification code, and that contain previously stored advertising data elements;
(f) automatically transmitting, from said second server computer to said user's computer using said network, data comprising an ad-history element that is sufficient to enable an executing software process to determine the total number of records in said result-set, and automatically storing said ad-history element in a storage means within said user's computer;
(g) automatically storing within said database, data-records comprising said advertising data elements, such that the data-records are associated with said user-identification code, thereby enabling said advertising data elements to be retrieved from said database at a future time by querying said database for data-records associated with said user-identification code;
(h) automatically responding to each user-generated selection event within one or more of said plurality of predetermined portions of said interactive operator controls by using said ad-history element to determine an ad-selection element, and transmitting data comprising said ad-selection element and said user-identification code to said second server computer using said network, and selecting a previously stored advertising data element from said database using said ad-selection element and said user-identification code and transmitting data comprising the previously stored advertising data element to said user's computer, and dynamically inserting the previously stored advertising data element in place of the advertising data element associated with the interactive operator control that received the user-generated selection event, thereby enabling a user of said user's computer to interactively display previously viewed advertisements within said interactive presentation,
whereby network delivered advertisements are provided additional, user-controlled presentations and therefore increased accessibility and effectiveness.

2. The method of claim 1 wherein said ad-selection element is an integer value that is an ordinal position within a set and the size of the set is determined using said ad-history element, and the selection of the previously stored advertising data element of said step (h) further comprises the sub-steps:
(h1) querying said database to provide a result-set comprising data-records that are associated with said user-identification code, and that contain previously stored advertising data elements, and that are ordered chronologically by time of storage within said database; and
(h2) selecting a data-record from the result-set having an ordinal position referenced by said ad-selection element.

3. The method of claim 1 wherein said viewing software application is a web browser application, and said interactive presentation is a web page presented using said web browser application, and said source file is of a type that can be processed by a web browser application to present a web page, and said advertising data elements comprise one or more portions within said web page that are specified using a markup-language, and said metadata identifiers are containment elements within said web page that can be dynamically accessed and modified using one or more software processes operating in conjunction with said web browser application.

4. The method of claim 1 wherein the data transmission of said step (d) further includes said second server computer automatically receiving said user-identification code by retrieving from said user's computer one or more web browser cookies containing said user-identification code, and the data transmission of said step (h) further includes said second server computer automatically receiving said user-identification code by retrieving from said user's computer one or more web browser cookies containing said user-identification code.

5. The method of claim 1 wherein the data transmission of said step (d) further includes automatically generating a new user-identification code within said second server computer, and automatically transferring the new user-identification code to said user's computer and storing the new user-identification code within a storage means therein, if:
said user-identification code is not received by said second server computer from said user's computer using said network.

6. The method of claim 5 wherein the new user-identification code is provided within one or more web browser cookies, and the one or more web browser cookies are stored within a storage means in said user's computer using a web browser application.

7. The method of claim 1 wherein at least one of said metadata identifiers in each set of said metadata identifiers assigned to said advertising data elements further includes predetermined configuration data sufficient to enable an executing software process to configure the color, size, transparency, source-image, and position of an interactive operator control, and the dynamic generation of interactive operator controls of said step (c) further includes using the predetermined configuration data included in said metadata identifiers to configure the color, size, transparency, source-image, and position of each of the interactive operator controls.

8. The method of claim 1 wherein at least one of said metadata identifiers in each set of said metadata identifiers assigned to said advertising data elements further includes a textual description of the advertising data element to which the set is assigned, and the transmitted data of said step (d) further includes the textual descriptions included within said metadata identifiers, and the stored data-records of said step (g) further include the textual descriptions.

9. The method of claim 1 wherein the data-records of said result-set are ordered chronologically by time of storage within said database, and further include textual descriptions of the previously stored advertising data elements contained therein, and said ad-history element comprises the textual descriptions, ordered chronologically by time of the data-records' storage within said database, thereby enabling an executing software process to determine the total number of records in said result-set by totaling the number of textual descriptions included in said ad-history element, and enabling an executing software process to interpret each textual description's ordinal position within said ad-history element as the ordinal position of a data-record within said result-set.

10. The method of claim 1 wherein said ad-history element comprises an integer value providing the total number of data-records in said result-set.

11. The method of claim 1 wherein said step (g) further includes limiting the stored data-records to only those data-records containing advertising data elements that are not duplicates of the previously stored advertising data elements contained in the data-records of said result-set, thereby preventing a user's multiple viewings of an interactive presentation from causing duplicate advertising data elements to be stored for that user in said database.

12. The method of claim 1 wherein said plurality of predetermined portions of said interactive operator controls further includes:
a back-button portion within each operator control, such that the user-generated selection event of said step (h), occurring within said back-button portion, will cause said ad-selection element to be determined by decrementing an index within a range of integer values defined by a predetermined minimum value and a maximum value determined from said ad-history element, and providing the value of said index as said ad-selection element, and
a next-button portion such that the user-generated selection event of said step (h), occurring within said next-button portion, will cause said ad-selection element to be determined by incrementing said index within a range of integer values defined by a predetermined minimum value and a maximum value determined from said ad-history element, and providing the value of said index as said ad-selection element,
whereby a user selecting said back-button portion or said next-button portion may sequentially display previously viewed advertisements within a chronologically ordered set of previously viewed advertisements.

13. The method of claim 1 wherein said plurality of predetermined portions of said interactive operator controls further includes a list-button portion within each operator control, such that the user-generated selection event of said step (h), occurring within said list-button portion, will cause said ad-selection element to be determined by:
first, automatically configuring the display area of the interactive operator control containing said list-button portion to further contain and present a list of textual descriptions of previously stored advertising data elements;
and second, automatically responding to a second user-generated selection event within the individual display boundaries of any of the textual descriptions by providing as said ad-selection element, an integer value representing the ordinal position of a data-record within a set of data-records selected from said database, the set of data-records also containing previously stored advertising data elements,
whereby a user operating said list-button portion may select and display previously viewed advertisements, in an order of the user's choosing, by selecting individual textual descriptions of the previously viewed advertisements.

14. An apparatus for increasing the accessibility and effectiveness of advertisements delivered via a network, having at least one user's computer connected by a network to a server computer, the apparatus comprising:
(a) ad-finder software executing in said user's computer that automatically finds advertising data elements within an interactive presentation by locating and accessing predetermined metadata identifiers assigned to said advertising data elements within said interactive presentation, and transmits, from said user's computer to said server computer using said network, data comprising said advertising data elements and a user-identification code that is predetermined, and receives from said server computer using said network, data comprising an ad-history element, and stores said ad-history element in a storage means within said user's computer, wherein said interactive presentation is displayed on a display device operatively connected to said user's computer and displays advertisements derived from said advertising data elements, and one or more of said advertising data elements were received using a network;
(b) ad-storage software executing in said server computer that automatically receives data transmitted from a user's computer using said ad-finder software and stores the advertising data elements included in the received data within data-records in a database accessible to said server computer such that the data-records are associated with the user-identification code included in the received data, and that generates and transmits to the user's computer, data comprising an ad-history element that is sufficient to enable an executing software process to determine the total number of data-records within said database that contain advertising data elements and that are associated with the user-identification code included in the received data;
(c) control-assignment software executing in said user's computer that automatically determines the locations of advertisements displayed within said interactive presentation by accessing the positional information of said predetermined metadata identifiers therein, and that dynamically generates and displays interactive operator controls at predetermined offsets relative to the determined locations of advertisements within said interactive presentation, such that each advertisement within said interactive presentation is provided an associatively positioned interactive operator control, wherein each interactive operator control is provided a plurality of predetermined portions that are individually responsive to user-generated selection events;
(d) ad-retrieval software executing in said server computer for automatically receiving data comprising an ad-selection element and a user-identification code from a user's computer using said network, and querying said database to provide a result-set comprising data-records that are associated with the user-identification code and that contain previously stored advertising data elements and that are ordered chronologically by time of storage within said database, and selecting a data-record from said result-set having an ordinal position referenced by the ad-selection element, and transmitting to the user's computer, data comprising the advertising data element contained in the selected data-record;
(e) ad-replacement software executing in said user's computer that provides dynamic replacement of individual advertisements displayed within said interactive presentation by using said predetermined metadata identifiers therein to locate and replace advertising data elements with other advertising data elements;
(f) ad-navigation software executing in said user's computer that responds to user-generated selection events within one or more of said plurality of predetermined portions of said interactive operator controls by providing, in response to each of the user-generated selection events, an ad-selection element determined using said ad-history element, and transmitting the ad-selection element and said user-identification code to said server using said network so that said ad-retrieval software may use the ad-selection element and said user-identification code to retrieve a previously stored advertising data element from said database and transmit the previously stored advertising element to said user's computer, and providing the received previously stored advertising data element to said ad-replacement software for replacement of the advertising data element associated with the interactive operator control that received the user-generated selection event, thereby enabling a user of said user's computer to interactively display previously viewed advertisements within said interactive presentation.

15. The apparatus of claim 14 wherein said interactive presentation is a web page presented by a web browser application, and each of said advertising data elements comprise one or more portions within said web page that are specified using a markup-language, and said predetermined metadata identifiers are containment elements within said web page that can be dynamically accessed and modified by said ad-finder software, said control-assignment software, said ad-replacement software, and said ad-navigation software operating in conjunction with said web browser application.

16. The apparatus of claim 14 wherein the transmission of said user-identification code by said ad-finder software further includes said server computer automatically receiving said user-identification code by retrieving from said user's computer one or more web browser cookies containing said user-identification code, and the transmission of said user-identification code by said ad-navigation software further includes said server computer automatically receiving said user-identification code by retrieving from said user's computer one or more web browser cookies containing said user-identification code.

17. The apparatus of claim 14 wherein said ad-storage software further includes automatically generating a new user-identification code, and automatically transferring the new user-identification code to said user's computer and storing the new user-identification code within a storage means therein, if:
said user-identification code is not received by said server computer from said user's computer using said network.

18. The apparatus of claim 17 wherein the new user-identification code is provided within one or more web browser cookies, and the one or more web browser cookies are stored within a storage means in said user's computer using a web browser application.

19. The apparatus of claim 14 further comprising an authentication means operating in said user's computer that accepts a user's entry of a login and password using an input means operatively connected to said user's computer and transmits the login and password to said server computer using said network, and settings-management software operating in said server computer for receiving and processing a login and password transmitted using a user's computer and said authentication means, wherein a login and password received from a user's computer by said server computer and determined by said settings-management software to be associated with a predetermined user-id code stored in said database will cause said settings-management software to locate data-records in said database that contain advertising data elements associated with the user-id code most recently transferred using said ad-finder software from the user's computer, and modify the association of the data-records so that they are associated with the predetermined user-id code, and transmit the predetermined user-id code to the user's computer for storage within a storage means therein, whereby a user viewing advertisements using a plurality of user's computers can cause the advertisements to be stored in association with a single user-id code and thus enable access, using any of the plurality of user's computers, to a complete collection of the user's previously viewed advertisements.

20. The apparatus of claim 14 wherein said plurality of predetermined portions of said interactive operator controls further includes:
a back-button portion within each operator control, such that a user-generated selection event occurring within said back-button portion, will cause the ad-selection element determined by said ad-navigation software to be determined by decrementing an index within a range of integer values defined by a predetermined minimum value and a maximum value determined from said ad-history element, and providing the value of said index as the ad-selection element, and
a next-button portion within each operator control, such that a user-generated selection event occurring within said next-button portion, will cause the ad-selection element determined by said ad-navigation software to be determined by incrementing said index within a range of integer values defined by a predetermined minimum value and a maximum value determined from said ad-history element, and providing the value of said index as the ad-selection element,
whereby a user selecting said back-button portion or said next-button portion may sequentially display previously viewed advertisements within a chronologically ordered set of previously viewed advertisements.

21. The apparatus of claim 14 wherein said plurality of predetermined portions of said interactive operator controls further includes a list-button portion within each operator control, such that a user-generated selection event occurring within said list-button portion will cause the ad-selection element determined by said ad-navigation software to be determined by:
first, automatically configuring the display area of the interactive operator control containing said list-button portion to further contain and present a list of textual descriptions of previously stored advertising data elements;
and second, automatically responding to a second user-generated selection event within the individual display boundaries of any of the textual descriptions by providing as the ad-selection element, an integer value representing the ordinal position of a data-record within a set of data-records selected from said database, the set of data-records also containing previously stored advertising data elements,
whereby a user operating said list-button portion may select and display previously viewed advertisements, in an order of the user's choosing, by selecting individual textual descriptions of the previously viewed advertisements.

22. The apparatus of claim 14 wherein the predetermined metadata identifiers assigned to each of said advertising data elements further include at least one predetermined metadata identifier containing a textual description of the advertising data element to which the predetermined metadata identifiers are assigned, and the data transmitted by said ad-finder software further includes the textual descriptions contained in the predetermined metadata identifiers, and the data-records stored by said ad-storage software further include the textual descriptions.

23. The apparatus of claim 14 wherein the ad-history element included in data transmitted by said ad-storage software comprises textual descriptions of the advertising data elements contained in data-records within said database that are associated with the user-identification code included in the data received by said ad-storage software, such that the textual descriptions are ordered chronologically by the data-records' time of storage within said database.

24. The apparatus of claim 14 wherein the ad-history element included in data transmitted by said ad-storage software comprises an integer value providing the total number of data-records within said database that are associated with the user-identification code included in the data received by said ad-storage software.

25. The apparatus of claim 14 wherein the data-records stored by said ad-storage software include only advertising data elements that are not duplicates of the previously stored advertising data elements within said database that are associated with the user-identification code included in the data received by said ad-storage software, thereby preventing a user's multiple viewings of an interactive presentation from causing duplicate advertising data elements to be stored for the user in said database.

26. The apparatus of claim 14 further comprising a Java applet executing in said user's computer that provides an intermediary communications service for said ad-finder software and said ad-navigation software, wherein all data transmitted from said ad-finder software and said ad-navigation software to said server computer, and all data received by said ad-finder software and said ad-navigation software from said server computer, are transferred using said Java applet and said network.

27. The apparatus of claim 14 further comprising at least one intermediary server computer providing intermediary communications services for said ad-finder software and said ad-navigation software, wherein all data transmitted from said ad-finder software and said ad-navigation software to said server computer, and all data received by said ad-finder software and said ad-navigation software from said server computer, are first transferred to said intermediary server computer using said network.

28. The apparatus of claim 14 wherein said user's computer is selected from the group consisting of a general-purpose computer, a wireless telephone, a portable Internet communication device, a personal digital assistant, a television, a set-top box, and a digital video recorder, and can communicate bi-directionally using said network and said server computer, display said interactive presentation, and receive and process user-selection events in conjunction with said interactive presentation.
